(19) United States
(12) Patent Application Publication
(10) Pub. No.: US 2011/0276395 A1
(43) Pub. Date: Nov. 10, 2011

(54) NEW AGE REAL ESTATE MARKETING METHOD AND SYSTEM

(76) Inventors: Jonathan L. Gaton, Huntington, WV (US); Kenneth Jackson, Huntington, WV (US)

(21) Appl. No.: 13/101,128

(22) Filed: May 4, 2011

Related U.S. Application Data
(60) Provisional application No. 61/331,167, filed on May 4, 2010.

(51) Int. Cl. G06Q 30/00

(52) U.S. Cl. 705/14.49; 705/26.41

(57) ABSTRACT

The present invention relates generally to a computer implemented system for the real estate marketing, and more particularly, to a computer implemented method/system that integrates both the present age networking technologies and the knowledge of the licensed real estate brokers and agents for marketing and facilitating real estate property transactions. The present invention provides instant communication among parties involved in the real estate transactions such as broker, real estate agents, sellers, buyers and vendors; convenient online auction, bidding and purchasing; prequalifying prospective buyers online; allowing prospective buyers to bid online on contingencies; business across a much larger geographic area, such as a state or multiple states; and knowledge and credibility from licensed broker and real estate agents so that both seller and buyers feel comfortable making deals online.

### REFERENCE TO RELATED APPLICATIONS

This patent application claims the benefit of U.S. Provisional Application No. 61/331,167 filed on May 4, 2010, the disclosure of which is incorporated herein by reference in its entirety.

### BACKGROUND OF THE INVENTION

1. Field of the Invention

The present invention relates generally to a business method and system for the real estate marketing, and more particularly, to a method utilizing the present age networking technologies integrated with the licensed real estate brokers and agents for marketing and facilitating real estate property transactions.

2. Description of Related Art

Real estate marketing has not changed a great deal over the years. Multiple Listing Services (MLS) has been the biggest influence of change in over 50 years. With the computer age came digital photos posted to MLS listing with search options, which gave the impression that the real estate business was moving forward, but MLS services today stop far short of bringing the industry into the age of instant communication.

To be brutally honest there are slim differences in the services offered among realty companies today. Most of the realty company websites use Multiple Listing Service (hereinafter “MLS”) for prospective buyers to search for homes from their corporate site; they do not display their own listings.

Online auction, bidding and purchase for other commodities are very common in the present age, but it is not common in the real estate property transaction. Auction is a more efficient means of conducting the real estate transaction. It allows the market to determine the price of the property. The current offer and acceptance method that has been utilized by the real estate business for years does not contemplate forces within the market that might allow for the property to sell for even more than the listing price as auction does.

Currently, there are existing networks or systems that make use of the internet to market real estate for buyers and sellers. However, the majority of these existing systems only offer users the ability to exchange properties for money or vice versa. Because a majority of the common people do not have specialized knowledge and ability to handle general sales procedures, determine fair market house value, or create necessary contracts. When the sellers proceed with selling real estate without a licensed real estate agent they often encounter complications in the real estate transaction process.

Among real estate companies, brokers and their agents typically contain their business to a small geographic area, such as a city or county. Indeed most companies operate with the same MLS and buyer/seller services as any other realty company in any city, so growing outside of a small geographic area is very unrealistic in today's market.

U.S. Pat. No. 6,321,202 B1 to Raveis, Jr. (2001) discloses a system and method for managing transactions relating to real estate and U.S. Pat. No. 6,594,633 B1 to Broerman (2003) discloses a real estate computer network; neither of the inventions provides tools for direct online auction (bidding) or prequalifying buyers. U.S. PreGrant Pub. No. 2006/0218070 A1 to Lange discloses a method of advertising, marketing, and auction sale of real estate properties and more particularly to a method of handling online bidding, the invention does not touch upon other features of marketing and facilitating transactions. U.S. PreGrant Pub. No. 2007/0050342 A1 to Inkinen et al. discloses a method for receiving real estate listing and search query and U.S. PreGrant Pub. No. 2008/0243922 A1 (2008) to Herm discloses a system and method for marketing real estate in which an advertising broker enters an agreement with a listing broker to place advertisements; neither of the inventions provides means for online transaction.

In view of the above deficiencies in the aforementioned real estate marketing methods and systems, there is a need in the art for an improved system and method for marketing and facilitating transactions that utilizes and integrates both the present age networking technologies and the specialized knowledge of the licensed real estate agents, which can provide instant communication among parties involved in the real estate transactions such as broker, real estate agents, sellers, buyers and vendors; convenient online auction, bidding and purchasing; prequalifying prospective buyers online; allowing prospective buyers to bid online on contingencies; business across a much larger geographic area, such as a state or multiple states; and knowledge and credibility from licensed broker and real estate agents so that both seller and buyers feel comfortable making deals online.

### SUMMARY OF THE INVENTION

The present invention is directed to a system and method for marketing and facilitating transaction of real estate properties. The present invention possesses many key fundamental differences from those existing today. The present invention is a business method that allows sellers to deal with a licensed real estate company. Once an agreement has been reached or a real estate has been bought, a seller will automatically be assigned with a licensed real estate agent. The benefit of having a licensed agent mediating the transaction for real estate generally involves the agent having the ability to understand contracts, general sales procedures, determining fair market house value, and creating necessary contracts. A majority of the common people do not have such specialized knowledge. If they proceed with selling real estate without a licensed real estate agent, they often encounter major complications in the real estate transaction process. The present invention will also allow the assigned agent to show a seller's property at public open houses during the auction period. In addition, the assigned real estate agent will show the home on individual basis to potential online buyers. Many existing real estate websites or systems do not offer this service. The real estate agents of this business method will be members of the realtor association. All documentation involved in real estate transactions will be signed electronically and will be handled by the licensed real estate agents.

The internet system involved with the present invention will also offer the buyer resources for financing as well. Recourses for seller such as attorneys and vendors for home warranties will also be offered. The present invention benefits sellers by simultaneously posting their listed homes onto the MLS directory as they post their homes onto the network for the present invention. This will allow the property to be available for other available licensed real estate agents.

The present invention relates to a new business model, method, and system for the purpose of marketing and facilitating real estate transactions over the internet with the oversight and assistance of Realtors, the licensed members of the National Association of Realtors. The method contemplates this system being used by any licensed real estate broker with affiliation to the realtor association. By using the present method and system, a single real estate company can market real estate exponentially throughout multiple states.

The method, system and web sites of the present invention are not designed to replace real estate agents, but to facilitate expedient and routine communications between the buyer and seller's agent with regard to the broker's own listings. These sites will cater to an ever increasing population whose preferences to communicate through personal computers and internet telephone devices are becoming difficult to ignore.

The present business model, method, system, and interactive website will be leased to licensed brokers who may hire or have contract with real estate agents. The method and system allow the brokers to present on the web site the broker's own listings together with the MSL listings. The method and system also allow the sellers post their own real estate for sale on the website including photos. The buyer can search the house from both broker's own listings and MSL listings. The buyers are able to see public open house schedule online they also have access to the listing agents' appointment book to schedule personal house viewing. The buyer is given opportunity to directly contact the seller if both buyer and seller agree to.

The method and system allow brokers the ability to prequalify prospective buyers and offer them the ability to make online offers through the current offer and acceptance method of real estate sales. The method and system also offer prospective buyers online bidding for property deemed by the broker/agent and seller as being more suitable for an auction selling format. The sites will offer email services between the agent and prospective buyer and other contact services. The method and system of the present invention also enable the buyer to make offer or bid online on contingencies. Common contingencies are built in the system to let the buyer choose.

The method and system also have capacity for advertisements of the real estate related industries such as lawyers, financial banks, house inspectors, etc. The advertisement or list of these real estate property related business provides convenience for buyers and sellers to expedite transactions and also increases revenues for brokers.

The method/system/web site provides direct online bidding auction, the method/system will quickly become the preferred method of buying and selling real property because the method/system seeks to find the true market value of each listing by design; the interactive nature of the method/system keeps everyone informed of buying and selling activity in real time and over a period of time; buyers, sellers as well as agent/brokers will be less dependent upon agent's time and resources and they will rely more on the online interactive selling method/system for many of their routine needs.

Among real estate companies, brokers and their agents typically contain their business to a small geographic area, such as a city or county. Indeed most companies operate with the same MLS and buyer/seller services as any other realty company in any city, so growing outside of a small geographic area is very unrealistic in today's market. However, since the interactive websites offers direct bidding auction method/system, the buyers do not need to be physically present when making bids. This online bidding method/system together with user friendly automation, convenience and time saving features provides advantages to geographically distant buyers. Thus, the brokers and realtors are getting what they need from doing business across a much larger area.

In summary, the method that integrates both present age networking technologies and the knowledge of licensed real estate realtors for marketing and facilitating real estate transaction according to the present invention includes the steps of entering into a contract between a broker and a seller of a real estate property; electronically receiving, storing, and accessing data relating to real estate properties; uploading and displaying the seller's real estate on a website; electronically communicating property information to prospective buyers over a computer network; prequalifying prospective buyers and offering them the ability to make online offers including auction bidding method and traditional offer and accept method; providing the seller online tools to accept or reject buyer's offers; electronically communicating (one way or two-ways) among all the parties including broker, listing agent, buyer's agent, buyer, seller, potential vendors; providing advertisement and communication tools of potential vendors that buyer may need upon closing a real estate transaction; and creating contingencies for the buyer to choose. The system including both hardware and software provides means for accomplishing the aforementioned steps.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of the general business method of the present invention;

FIG. 2 is a flow diagram of the present invention between a buyer and a seller;

FIG. 3 shows what features are available to the buyer with the present invention;

FIG. 4 shows what features are available to the seller with the present invention;

FIG. 5 shows what features are available to the listing agent with the present invention; and

FIG. 6 shows what features are available to the buyer's agent with the present invention.

### DESCRIPTION OF THE PREFERRED EMBODIMENT

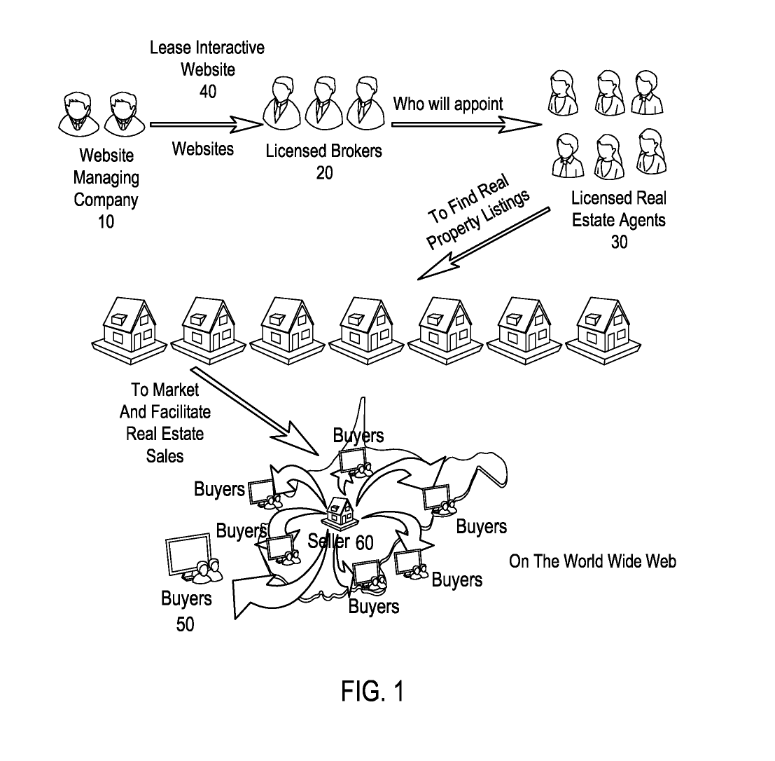

Referring to FIG. 1, there is disclosed a flow diagram of the general business method of the present invention. The website managing company 10, using lease Interaction Website 40 will lease to licensed brokers 20, who will work with real estate agents 30 that allow brokers 20 the ability to prequalify prospective buyers 50 and allow them the ability to make online offers through the current offer and acceptance method or online bidding for property deemed by the broker and seller as being more suitable for an auction selling format. The method offers network communication between buyers 50 and sellers 60. This business method is not designed to replace real estate agents 30 but to facilitate expedient and routine communications between the buyers 50 and seller's agent 30 and/or sellers 60.

The method/system allows visitors to explore the site without registering. In one embodiment, site's Home page displays the broker's header at the top, and this will be customized to support any broker's color schemes and graphics for a unique and appealing look. Below the site header at the top of the page will be cells for information such as: BUYER ADVICE, SELLER ADVICE, OUR AGENTS, SITE TUTORIAL and LOGON, etc. In another embodiment, below the site header will be cells for information such as: OUR LISTINGS, ALL LISTINGS, OUR AGENTS, BUYER SERVICES, SITE TUTORIAL and LOGON, etc.

The OUR AGENTS cell is a common cell of information among any of today's realtors regarding information about the broker's agents. This area, as it does on most realtor sites will display photos of the broker's agents, the credentials and contact information of each one of them.

The SITE TUTORIAL is the cell designed to show visitors or new users (It should be recognized that the “user” and “visitor” will be used interchangeably throughout the specification) of the system all the features and functionality that is available to them. It may be a brief film tutorial about the features of the site. It may discuss seller features and buyer features, as it shows screens and offers narration to walk people through registration, posting photos, bidding, scheduling of appointments, email and so forth.

Afterwards the visitor may apply for a user name and password in order to use the facilities of the site.

Once the visitor logs on and enters into the site they are automatically taken to the listings tab by default. The first time the users enter the listing tab they are asked the zip code or city and state of their area of interest. Once declared the system will remember the area of interest, and go there immediately for future visits to the site. The system remembers the last area of interest the buyer or seller visited and stores it as the default for that visitor. The system will bring to the attention of the visitor the requested zip code and several other zip codes within the area to give the visitor plenty to review within a reasonable radius. Once the area is declared a featured home will always be displayed in the center of the page for buyers to review immediately, and it will change on a rotational basis automatically based upon certain criteria such as home value, appealing photo and so forth. In another embodiment, the visitor can search the property listings without logon.

On the left of the page will be a menu of options that include:
1. My Messages
2. My Hot List
3. Sellers
4. New Search

From the listing tab a sub tab labeled “Our Listings” will display all the broker's own listings within the specified area the buyer chooses to review from most expensive to least. It is the cell in which direct bids or offers from prospective buyers will originate from the buyer's computer or internet compatible cell phone, and go directly to the listing agent via internal email. This area will display scheduled public viewings of the listings, or allow access to the listing agent's appointment book to schedule a private showing. This cell will display questions and answers regarding the listing. It will display statistics regarding the number of times the listing has been visited and the number of bids or offers that have been made on the listing. It will have multiple photos and the availability to post videos to the listing, a photo of the listing agent and the ability to click and email the agent with questions or concerns.

Next to the sub tab listing labeled “Our Listings” will be another sub tab labeled “All Listings”, and this will be the MLS listings, which will include the broker's own listings. This means that the broker's own listings will be posted on the World Wide Web in two places, through MLS and “Our Listings”. This gives the seller more exposure for the same fees.

On the listing will be up to 15 to 20 photos, a description, the address, the date the sale ends, public showing dates as well as a link to the listing realtor to schedule a private showing or ask a question. The buyer will be able to place a bid, but they will need to be prequalified first. If they are working with a buyer's agent they will need to identify their agent's name. This tells us that the buyer was first prequalified through a realtor. If they have no buyer's agent the bidder will need to answer a brief questionnaire prior to bidding on properties to qualify the bidder as a buyer.

Once qualified the bidder may make a bid, and the bid will go directly to the seller, but the buyer's agent and listing agent will get a copy. If the bidder chooses to bid with contingencies that is no problem, but the bidder will either call or email the buyer's agent (if any) or listing agent first to arrange the contingency. They will be prompted to do this by the system's screen flow. Bidding will continue as such until the sale ending date.

The seller may opt to choose the “Purchase Now or Make Best Offer” method to sell the property. This is done in the same manner as the system's online auction, but the sale can end sooner than the sale ending date. The buyer and seller just need to agree on the price. Once that happens both parties are ready to sign a sales contract.

This selling method/system can work in conjunction with the current MLS system. Buyer's agents and brokers who are outside of the broker system of the present invention may enter the system to obtain a buyer's agent user name and password. This will allow the buyer's agent certain privileges to exercise within the system, but it is only to facilitate the unique system of marketing real estate. The buyer's agent may not make listings themselves or make any alterations to current listings. They may choose from a list of contingencies that are built into the system already, or create one and forward them on to the listing agent for consideration for the sake of their buyers. The listing agent will have the final draft on any contingency or seller concession, and all of this will be performed through the selling system.

Provisional contingencies are condensed, conceptual ideas, clearly reflecting the intent of the buyer, written in plain language to help bring the buyer and seller to a basic form of agreement through this medium prior to the use of complete language in the sales contract. A broker and agent may look upon this medium as a starting point to get a contract in motion. The method/system is designed to facilitate routine communications only.

Contingencies and seller concessions are a part of real estate transaction, and all contingencies and seller concessions will be reviewed by the listing agent first before they are sent on to the seller for consideration. The listing agent will have discussed many of the contingencies that are common for real estate sales with the seller at the time the property is listed. Common contingencies will be built into the system already, and listing agents as well as buyer, and buyer's agents will be able to choose them from a menu. The listing agent will be required to call and discuss new contingencies with the seller before putting them in writing for their approval. New contingencies that are not built into the system can be made a part of the purchase agreement, but no bid will be permitted until the contingency is understood and agreed upon by the seller first. All contingencies will be kept hidden from other buyers and will be permanently saved and stored as a part of the agreement between the bidder and seller individually until the property closes. It will be the responsibility of the listing agent to properly author the wording of new contingencies. It will also be the responsibility of the listing agent to make the seller understand the contingency prior to accepting the contingency as part of any agreement between bidder and the seller.

Some contingencies such as, the ability to obtain financing will be granted, but it will be turned back on the bidder as they will have a specified number of days to apply for preapproved financing and a specified number of days to secure preapproval, and if it is not obtained within the allotted time their bid will be rejected. The system will remind the buyer of the time limitations via email. Preapproval and application for financing will be able to be done right from the web site, and this will be discussed later.

The buyer may click a button to “Make an offer” or click on a button to “Make Offer Subject To”. In one embodiment, when the buyer click “Make Offer Subject To” which will open up a form to fill in the buyer's offer with a drop down menu of common provisional contingencies that they may place on their offer before sending to the listing agent. The provisional contingencies will have a screen of conditions that must be met by the buyer, which will be displayed after choosing the contingency. The buyer must agree to the conditions or the offer will be terminated, and the buyer returns to the listing.

To put this into better perspective, an example of the contingency to offer subject to the ability to obtain financing is used. Once this is selected a screen of conditions will pop up before the buyer. The screen will have language to the effect that this contingency will most likely be accepted with the offer as long as the buyer:

1. Agrees to apply for pre-approval for financing within a week of this offer.
2. Produces a letter to the listing agent that financing is available to the buyer within 30 days of the offer.

There may be other conditions that apply to this contingency. This is only an example. The buyer will be asked at the bottom of the conditions form; Do you agree to these conditions? The buyer may click on “Yes”, and be allowed to chose from other provisional contingencies, or send the offer with the one contingency. The buyer may click “No” and they will be taken back to the listing page.

Provisional contingencies are normally condensed, conceptual ideas, clearly reflecting the intent of the buyer, written in plain language to help bring the buyer and seller to a basic form of agreement through this medium prior to the use of complete language in the sales contract. A broker and agent may look upon this medium as a starting point to get a contract in motion. The system is designed to facilitate routine communications only.

Once a sales agreement has been reached between a buyer and a seller all contingencies and/or seller concessions are brought together by the internet selling system to be made part of the sales contract. The agent simply prints the contract for buyer and seller to review, but rather than signing a hard copy the agent will secure contract signatures from both parties with an electronic signature pad. Once signatures are obtained we have a contract, and all parties will receive a copy via email.

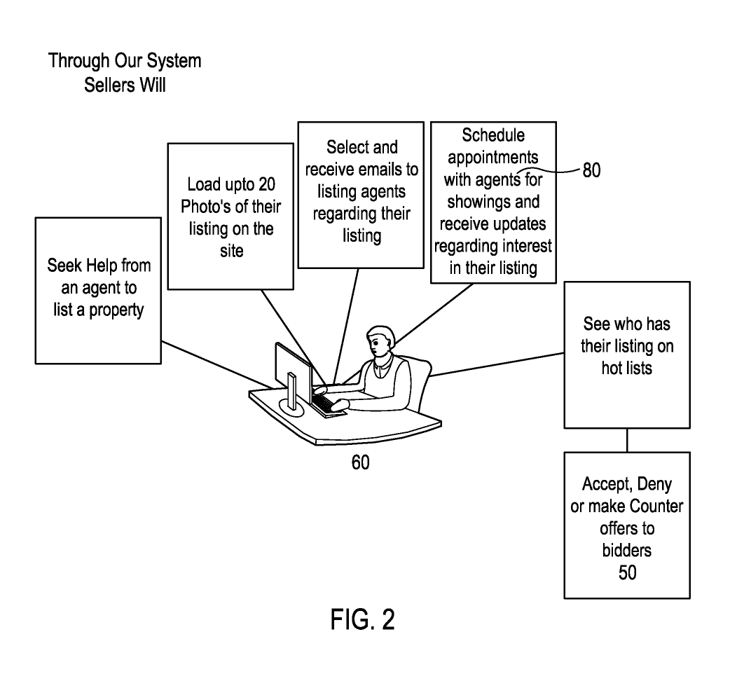

FIG. 2 shows what features are available to the seller 60 with the present invention. Through the method/system of the present invention, the seller 60 can seek help from an agent to list a property, load up to 20 photos of their listing on the site, send and receive emails to listing agents regarding their listing, schedule appointment with agents for showings and receive updates regarding interest in their listing 80, see who has their listing on hot lists, and accept, deny, or make counter offers to buyers (bidders) 50.

Insofar as the online auction method is concerned all properties will have an “Initial Bid” or starting point that the seller chooses with the aid of the listing agent, and this will be the least amount that a seller would be willing to accept for the property. A pure auction will be conducted for the property straight through the “Sale Ending” date, to the hour, minute and second the auction ends. Auction is a valuable tool that is seldom facilitated among mainstream realty companies today. It is both useful and fun for the buyer and seller, and a great tool to be utilized for the right instances.

At the discretion of the seller and upon the advice of the listing realtor a “Purchase Now” or “Make Best Offer” price can be substituted for the online auction, and if the buyer accepts the “Purchase Now” price the seller and the buyer can close immediately. Otherwise the buyer may make an offer and submit it to the seller for consideration.

The “Purchase Now” or “Make Best Offer” needs to be reasonably in line with the market value of the property, and the listing agent will be within arm's length to provide assistance for the seller. It is intended for those that need to be able to buy property quickly, without waiting until the “Sale Ending” date. It is also intended for sellers that need a quick sale, and the listing agent will be familiar with what properties this option might be appropriate. Auction or Offer and Acceptance, it's a decision the seller needs to make with the assistance of the listing agent.

The seller will have access to immediate updates generated by the system as to the interest in their listing. They will be able to see that someone is visiting the listing now, or they will be able to see how many people visited their listing in days, weeks or months, and how long each stayed or visited. They will be able to see user names of those that have placed their listing in their hot list. The seller will be able to see a calendar as to the availability of their home for showing which will be available for all to see from the site of the listing. These features which take valuable time today will be automated through the system.

In an embodiment of the invention of an Offer and Acceptance method, from among the broker's own listing, And from among MLS listings placed on a broker's IDX website a button or function called MAKE AN OFFER is available to choose. This is an entrance to an online communications format designed to help the Buyer make an offer that will be presented to the Seller complete with contingencies and Seller concessions.

Information regarding the listing and the Buyer is populated into the forms of this tool when the MAKE OFFER button is depressed. A brief questionnaire ascertains if the Buyer is working with an exclusive buyer's agent; if not the Buyer may proceed into the process.

The buyer is presented in layman terms with the aid of videos, audios, photos and other devises the concepts, choices and legal clauses of a CONTRACT TO PURCHASE in its entirety. The Buyer's choices and selections are recorded on the appropriate areas of an actual CONTRACT TO PURCHASE of a version that is widely accepted in the area the property is situated. When the Buyer has completed the online process a CONTRACT TO PURCHASE is complete based upon the Buyer's choices and preferences.

The Buyer may revieW or print the contract to purchase by the click of a button prior to sending. The Buyer clicks “SEND” to move the contract on to the broker/agent that leases the invention.

The broker's agent receiving the contract reviews it for completeness, accuracy, omissions or errors; The realtor may send the contract back to the Buyer to add provisions or contingencies, but once the realtor is satisfied with the construction of the offer it is sent to DocuSign software to ;prepare it for the Buyer's signatures and initials. The contract is then forwarded electronically to the Buyer. Once the contract is returned to the agent the offer is ready to present to the Seller.

When the Seller reviews the contract the agent takes careful notation of any problems the Seller may have with the offer. The Seller may accept, deny or make a counter offer back to the Buyer.

The agent responds back to the Buyer through the same online devise that the Buyer used when making the offer noting to the Buyer any provisions or contingencies the Seller has denied. The agent also forwards comments to the Buyer to help bring agreement between the Buyer and Seller. The Buyer may react by accepting or denying any counter offer, resubmitting another offer, or simply walking away. The process may continue as long as needed until an agreement is reached. All contract modifications that have been approved or denied are saved and stored between the two parties should the process be abandoned.

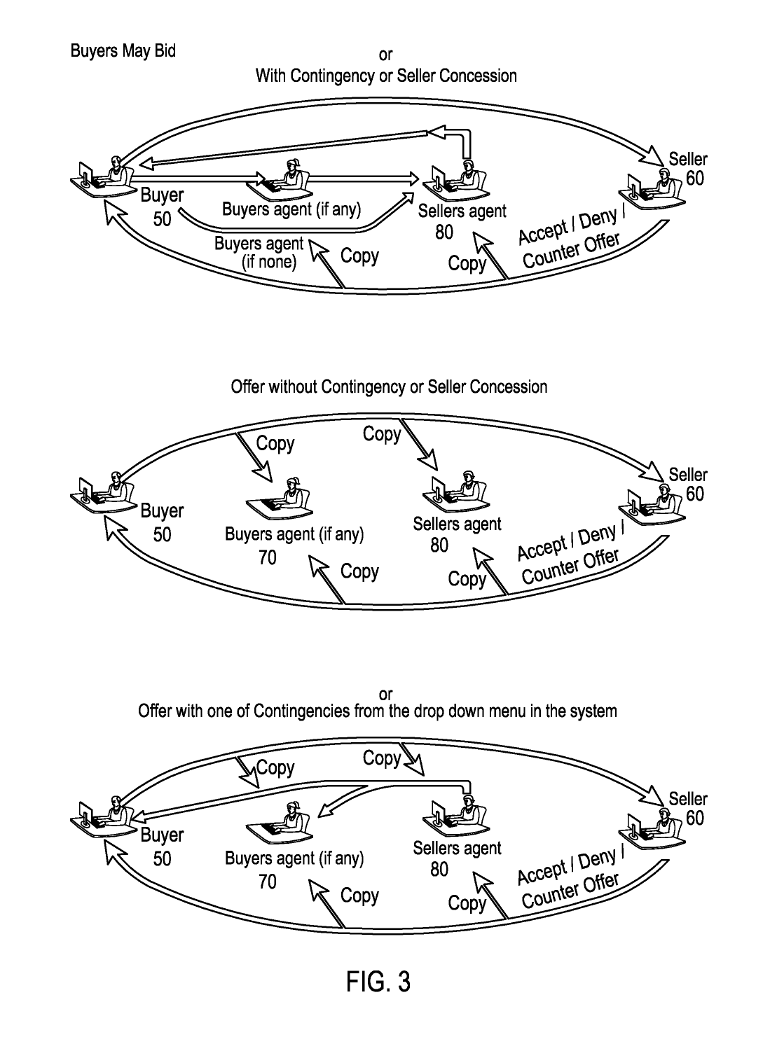

Referring now to FIG. 3, there is illustrated a flow diagram of an embodiment of the present invention between a buyer and a seller. The seller 60 will be able to receive bids from buyers (bidders) 50 directly, though all bids will be copied to the buyer's agent (if any) 70 and Seller's (listing) agent 80. The seller 60 will be able to accept a bid through the “Purchase Now or Make Best Offer” option, and copy will be sent to the buyer's agent (if any) 70 and Seller's (listing) agent 80. Otherwise the seller 60 will watch as the bidding goes up on their listing until the close of the property.

The buyer 50 will be able to place a bid from the web site on their own without the assistance of realtors. They may choose to make a bid on a listing without contingency. They may choose to make a bid on a listing with a contingency that is already stored in the system and can be selected from the drop down menu. The contingency will be forwarded to the Seller's (listing) agent 80 and seller 60 together with the bid for review. Alternatively, if the buyer is working with a buyer's agent 70 , the contingency may begin with the buyer's agent 70. The buyer's agent 70 will begin by choosing from one of the contingencies listed in the buyer's agent drop down menu. It is then forwarded to the listing agent for review. If the buyer 50 wants to make a bid on a listing with a contingency that is not stored in the system, it can only be facilitated by a realtor. If the buyer is working with a buyer's agent 70, the buyer's agent 70 will begin by drafting the new contingency and forwarded to the listing agent 80 for review. The listing agent 80 and seller 60 will have the final say on the draft of any new contingency. If the buyer 50 does not have a buyer's agent 70, the buyer 50 may choose to work with the listing agent 80 to initiate and formalize the new contingency for the purchase.

Buyers 50 will be updated via email for all matters that concern the properties that they are bidding on, and the properties that appear on their hot list. Buyers 50 will receive emails on relisted property for which the buyer 50 had shown prior interest. Buyers 50 will receive email messages when they have been outbid on a property they have bid on. They will receive email when properties found on their hot list are holding a public showing, or when new questions and answers about the listing are posted.

A photo of the listing agent, their phone number and email will be posted on the listing for people to present questions, schedule property showing, or contact to add contingencies on bidding. All questions and answers will be posted for everyone to see.

The method and system may further provide a buyer service which is optional at the discretion of both the website managing company and the broker, and will be a unique cell in which vendors may advertise on the broker's site.

Buyers who will eventually need the services of lawyers, insurance companies, pest control, furniture movers and so forth will find it very easy to contact reputable vendors directly from one of the sites in the market area for quotations for these very services and more.

When this cell is opened by the visitor a series of sub tabs will be displayed labeled with each of the services that a buyer might need upon closing a real estate transaction. Within each of these sub tabs is a form to complete pertaining to the service the visitor seeks. The user completes the form with their home email address as the return address for the vendor. The user will see displayed on the page a number of vendors. It could be an extensive list that could go into a second page if needed. As their cursor rolls over one of the listed vendors the user may click on any vendor and it will populate the vendor's email address into the “To” section of the quotation request form. It is possible that multiple vendors can operate under the same corporate name, but the user may click on only one vendor per company name. No vendor will have knowledge of the other vendors that have also received the form. Quotations for the services will be sent via email to the user's home email address.

This advertising will actually be better than the Yellow Pages or Google for the vendor because all the information needed for a quotation is sent to the vendor from prospects that will eventually be needing their services at some point in the sales process. Users will like this because they fill out one form per service, and it will go out to multiple service providers. Their quotations will be fed to them via email. It is a convenience and benefit for both the user and vendor.

In one embodiment, next to the Listings Tab at the top of the page is a tab called BUYER SERVICE. From the BUYER SERVICE tab a sub tab labeled “Finance”. The Finance tab will allow buyers to apply for loan preapproval at any time in the process with the aid of a generic form for that purpose, and it may be sent to a list of any number of financial institutions listed by corporate icons on the tab. After the buyer chooses his home he will be able to complete and upload a generic loan application to one or many financial institutions listed by colorful corporate icons on the Finance tab.

Next to the Finance tab there will be a Legal Services tab. A generic form can be completed from the site and sent to one or more legal firms in the area for the buyer to obtain estimates for legal services pertaining to their closing.

Next to the Legal Services tab will be a tab for Insurance, and the buyer will be able to complete a generic form that can be forwarded to one or many insurance agents in the area from insurance icons listed on this tab, and this will assist in getting the buyer a homeowner quote on the property.

From the web site a wide variety of services can originate to assist the buyer with every facet of their needs when buying property, and even more tabs can be added later on such as pest control services, or moving and storage. The point and purpose is to make the site a one stop shopping service for real estate buyers.

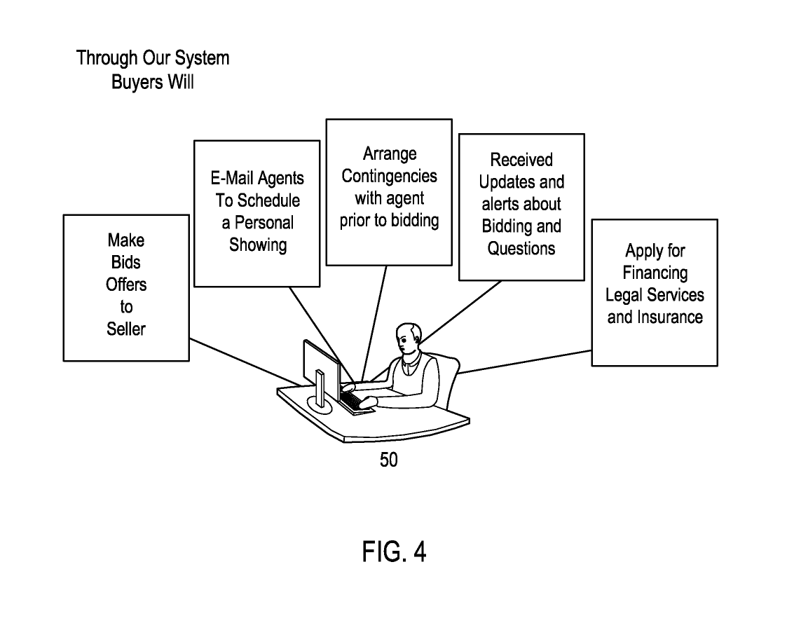

FIG. 4 summarizes what features are available to the buyer 50 with the present invention. The buyers 50 may email agents to schedule a personal showing, arrange contingences with agent prior to bidding, make bids offers to seller, receive updates and alerts about bidding and questions, apply for financing, insurance, and legal services.

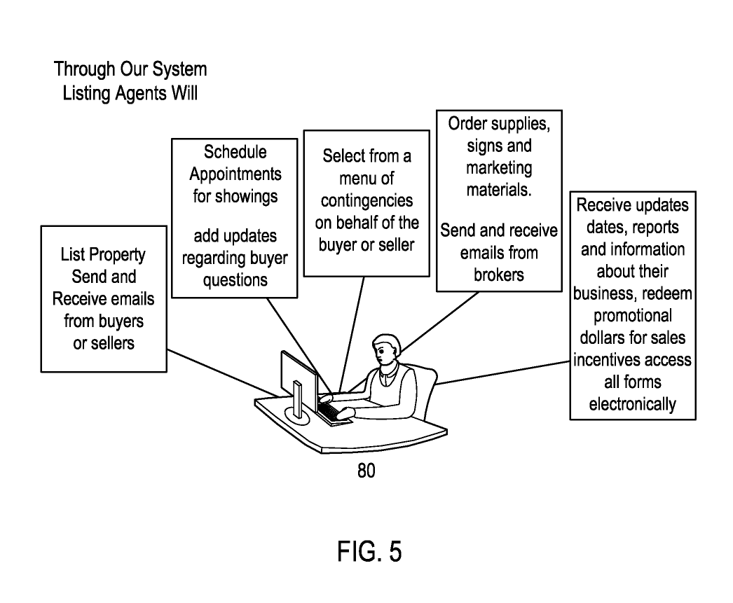

The method and system of the present invention not only provides a buyer and seller friendly, interactive internet transaction web site. It offers everything the listing agent needs to conduct and grow their business, whether they choose to do business from the hood of a car or a table in a McDonald's restaurant. As shown in FIG. 5, through the method/system of the present invention, the listing agents 80 can list property, send and receive emails from buyers or sellers; schedule appointments for showings; add updates regarding buyer questions; select from a menu of contingencies on behalf of the buyer or seller, order supplies, signs, and marketing materials; send and receive emails from brokers; receive updates, reports and information about their business, redeem promotional dollars for sales incentives, and access all forms electronically. They will have the capability to access every single form they need from within the agent's site of this selling system. Any form may be completed electronically, and agents may obtain all signatures through the use of an electronic signature pad as long as all parties involved get copies emailed to them. Form updates will occur from within the corporate site, so agents and brokers will not need to concern themselves if they are using the updated forms.

A sales contract for instance will actually begin being constructed as offers from the buyer with or without contingencies are coming into the seller. Each contingency or seller concession will be stored between the two parties and if a sales agreement occurs the only thing left to do will be to print the contract between the two parties for review, and have each party's signature to the document by electronic signature pad. Utilizing the present method and system, the agent will be able to list properties for the seller, send or receive emails from buyers or sellers, author seller concessions or buyer contingencies, schedule appointments, review sales statistics, reports and much more. All brochures, canvassing materials, realty signage and even office supplies will be able to be ordered through the broker/agent site as a convenience to the agent.

The method and system provides online bidding auction which is a more efficient means of conducting the real estate transaction. It allows the market to determine the price of the property. The current offer and acceptance method that has been utilized by the real estate business for years does not contemplate forces within the market that might allow for the property to sell for even more than the listing price as auction does. The method and system of the present invention provides the following benefits: 1. the system seeks to find the true market value of each listing by design; 2. the interactive nature of the system keeps everyone informed of buying and selling activity in real time and over a period of time; buyers, sellers as well as agent/brokers will be less dependent upon agent's time and resources and they will rely more on the online interactive selling system for many of their routine needs.

Among real estate companies, brokers and their agents typically contain their business to a small geographic area, such as a city or county. Indeed most companies operate with the same MLS and buyer/seller services as any other realty company in any city, so growing outside of a small geographic area is very unrealistic in today's market. However, since the interactive websites offers direct bidding auction system, the buyers do not need to be physically present when making bids. This online bidding method and system together with user friendly automation, convenience and time saving features provides advantages to geographically distant buyers. Thus, the brokers and realtors are getting what they need from doing business across a much larger area.

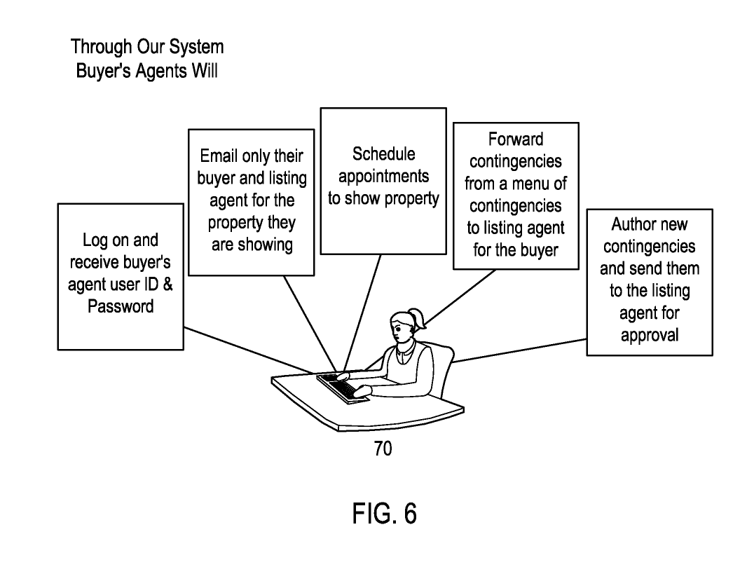

FIG. 6 shows what features are available to the buyer's agent 70 with the present invention. Buyer's agent can log on and receive buyer's agent user ID and password, email only their buyer and listing agents for the property they are showing, schedule appointments to show property, forward contingency from a menu of contingencies to listing agent for the buyer, author new contingencies and send them to the listing agent for approval.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of using a computer that performs transaction steps for marketing and facilitating a real estate transaction comprising the steps of:
(a) entering into a contract between a broker and a seller of a real estate property;
(b) electronically receiving, storing, and accessing data relating to real estate properties;
(c) uploading and displaying the seller's real estate on a website;
(d) electronically communicating property information to prospective buyers over the internet to a second computer;
(e) prequalifying prospective buyers and offering them the ability to make online offers;
(f) providing the seller online tools to accept or reject buyer's offers; and
(e) electronically communicating (one way or two-ways) via the internet among all the parties including broker, listing agent, buyer's agent, buyer, seller, potential vendors.

2. The method of claim 1 further comprising a step that allows visitors to do quick searches from broker's own listings and the multiple listing services (MLS) listings.

3. The method of claim 1 further comprising a step of allowing brokers the ability to create an income stream from advertisement of potential vendors that a buyer may need upon closing a real estate transaction on the website; the potential vendors include but are not limited to lawyers, finance companies, insurance companies; the website has capacity to let the prospective buyers directly contact reputable vendors for service quotations from the broker's website.

4. The method of claim 3, wherein the buyer may select potential vendors from a vendor list provided by the website; it will populate the vendor's email address into the “To” section of the quotation request form;
and let the buyer email the vendor through the website.

5. The method of claim 1, wherein the buyer may make online offers through direct online bidding auction method.

6. The method of claim 1, wherein the buyer may make offers through traditional offer and acceptance method.

7. The method of claim 1 further comprising steps of creating provision contingencies; reviewing contingencies; and approving contingencies.

8. The method of claim 7 further comprising a step of electronically storing the approved common contingencies and built into the website as a drop down menu for the buyer to choose.

9. The method of claim 1 wherein the buyer may make an offer with and without provisional contingencies that are build into the website.

10. The method of claim 9, wherein if the buyer chooses to make an offer with provisional contingencies, a drop down menu of common provisional contingencies will appear for buyer to choose.

11. The method of claim 1, wherein the offers may be originated from the prospective buyer's computer or internet compatible cell phone and directly go to the listing agent.

12. The method of claim 1 further comprising steps of accessing and displaying information, photos, statistic data about the house; accessing and displaying information about listing agent; and accessing and displaying scheduled public open house.

13. The method of claim 1 further comprising a step of accessing to the listing agent's appointment book to allow the buyer to schedule a private showing.

14. The method of claim 1, wherein the interactive websites can be leased to real estate brokers in multiple states; the interactive websites can be leased to a real estate company to facilitate growth of real estate transaction and/or it may be leased to a multiple listings service vendor so that the websites can be employed by al agents throughout many local associations.

15. The method of claim 1, wherein layman (plain) languages are used in the website to help bring the buyer and seller to a basic form of agreement prior to the use of legal verbiage in sales contract.

16. A computer implemented system using a computer including hardware and software for marketing and facilitating real estate transaction comprising:
(a) means for entering into a contract between a broker and a seller of a real estate property;
(b) means for electronically receiving, storing, and accessing data relating to real estate properties;
(c) means for uploading and displaying the seller's real estate on a website;
(d) means for electronically communicating property information to prospective buyers over a computer network;
(e) means for prequalifying prospective buyers and offering them the ability to make online offers;
(f) means for providing the seller online tools to accept or reject buyer's offers; and
(e) means for electronically communicating among all the parties including broker, listing agent, buyer's agent, buyer, seller.

17. The system of claim 16 further comprising a means for visitors to do quick searches from broker's own listings and the multiple listing services (MLS) listings.

18. The system of claim 16 further comprising means for creating provision contingencies; reviewing contingencies; approving contingencies; and storing common contingencies and built into website as drop down menu for prospective buyers to choose.

19. The system of claim 16, wherein means for online offer including online auction bidding and traditional offer and acceptance method.

20. The system of claim 16 further comprising means for putting advertisement of potential vendors that a buyer may need upon closing a real estate transaction on the website.
